(19) United States
(12) Patent Application Publication
(10) Pub. No.: US 2022/0386230 A1
(43) Pub. Date: Dec. 1, 2022

(54) Radio Access Technology Prioritization

(71) Applicant: Apple Inc., Cupertino, CA (US)

(72) Inventors: Rohit R. Matolia, Bangalore (IN); Vijay Venkataraman, San Jose, CA (US); Alosious Pradeep Prabhakar, Singapore (SG)

(21) Appl. No.: 17/737,603

(22) Filed: May 5, 2022

(30) Foreign Application Priority Data
May 27, 2021 (IN) 202141023695

(51) Int. Cl. H04W 48/20; H04W 24/10; H04B 17/318

(52) U.S. Cl. CPC H04W 48/20; H04W 24/10; H04B 17/318; H04W 84/042

(57) ABSTRACT

This disclosure relates to techniques for determining a radio access technology to prioritize when obtaining cellular service in a wireless communication system. A wireless device may determine whether to deprioritize obtaining cellular service using a radio access technology. Whether to deprioritize obtaining cellular service using the RAT may be determined based at least in part on one or more cellular network characteristics. The wireless device may establish a wireless link with a cellular base station. The wireless link may be established with the cellular base station based at least in part on the determination of whether to deprioritize obtaining cellular service using the radio access technology.

### PRIORITY CLAIM

This application claims benefit of priority to Indian Application No. 202141023695, titled “Radio Access Technology Prioritization”, filed May 27, 2021, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for determining a radio access technology to prioritize when obtaining cellular service in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for determining a radio access technology to prioritize when obtaining cellular service in a wireless communication system.

The techniques may include the use of a variety of cellular network characteristics and conditions, as well as wireless device characteristics and conditions, for determining when to prioritize, deprioritize, and/or re-prioritize one or more radio access technologies. For example, if certain wireless device conditions are met for deprioritizing a certain radio access technology, such as for battery conservation at the wireless device, any or all of various possible cellular network related considerations that could impact whether deprioritizing that radio access technology would serve the desired goal (e.g., battery conservation) at the wireless device and/or whether such deprioritization could have (or is having) other unintended negative impacts may also be evaluated and used by the wireless device when determining whether to actually deprioritizing the radio access technology. Such impacts could include no or limited cellular service and/or other (e.g., Wi-Fi) wireless communication service, or loss of revenue for the home public land mobile network of the wireless device, or any of various other possible considerations.

Thus, the techniques described herein may help a wireless device to better balance power consumption and performance, for example by improving the wireless device's capability to evaluate whether prioritizing, deprioritizing, and/or re-prioritizing a radio access technology may benefit the wireless device at various times and in various circumstances, at least according to some embodiments.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for determining a radio access technology to prioritize when obtaining cellular service in a wireless communication system, according to some embodiments;

FIGS. 6-7 are signal flow diagrams illustrating exemplary aspects of various possible radio access technology deprioritization scenarios, according to some embodiments; and

FIGS. 8-13 are flowchart diagrams illustrating various possible aspects of radio access technology prioritization techniques, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:

UE: User Equipment

RF: Radio Frequency

BS: Base Station

GSM: Global System for Mobile Communication

UMTS: Universal Mobile Telecommunication System

LTE: Long Term Evolution

NR: New Radio

TX: Transmission/Transmit

RX: Reception/Receive

RAT: Radio Access Technology

TRP: Transmission-Reception-Point

DCI: Downlink Control Information

CORESET: Control Resource Set

QCL: Quasi-Co-Located or Quasi-Co-Location

CSI: Channel State Information

CSI-RS: Channel State Information Reference Signals

CSI-IM: Channel State Information Interference Management

CMR: Channel Measurement Resource

IMR: Interference Measurement Resource

ZP: Zero Power

NZP: Non Zero Power

CQI: Channel Quality Indicator

PMI: Precoding Matrix Indicator

RI: Rank Indicator

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

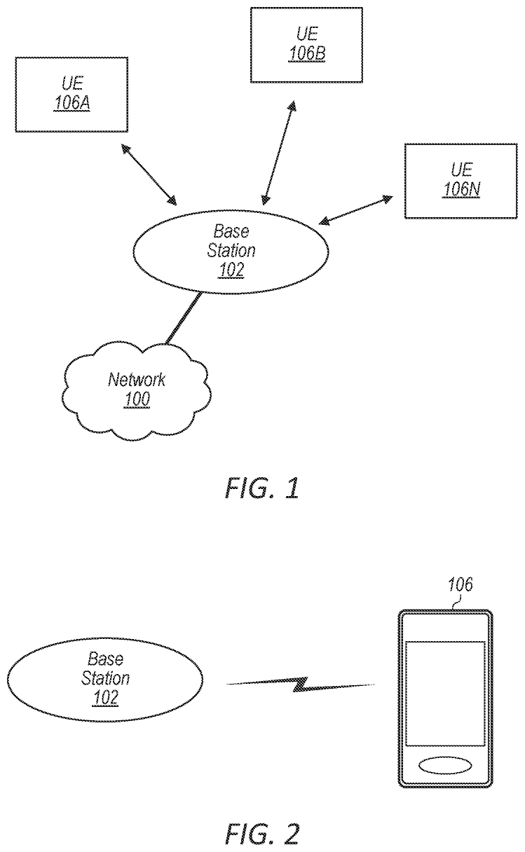

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for determining a radio access technology to prioritize when obtaining cellular service in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

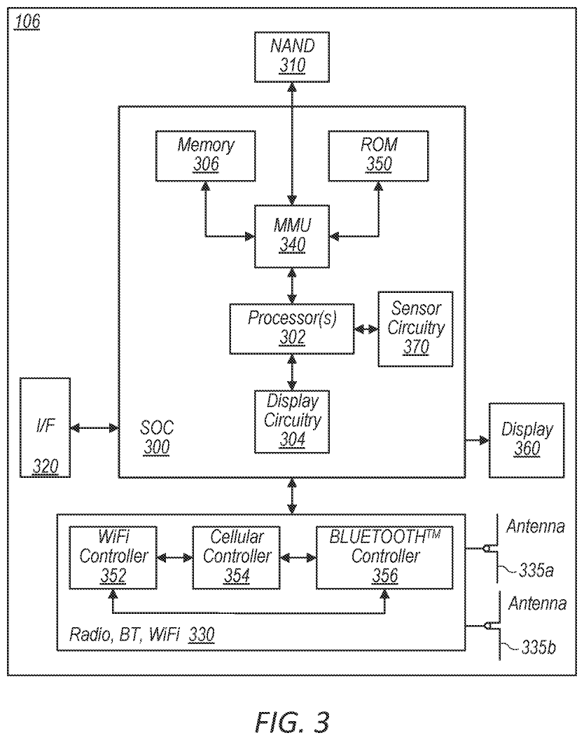

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing methods for the UE 106 to perform techniques for determining a radio access technology to prioritize when obtaining cellular service in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for determining a radio access technology to prioritize when obtaining cellular service in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g. LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

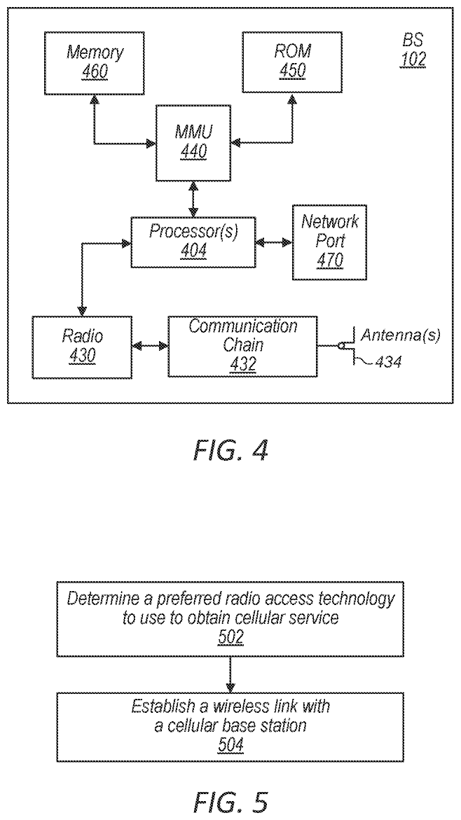

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard.

### FIG. 5—Radio Access Technology Prioritization

Numerous wireless communication technologies/radio access technologies have been developed, and new wireless communication technologies as well as updates to existing wireless communication technologies are continually under development. As such, many wireless devices implement the capability to perform wireless communication according to multiple wireless communication technologies, potentially including multiple cellular communication technologies, Wi-Fi, Bluetooth, etc.

Different wireless communication technologies may be available at different times and/or locations for a given wireless device, likely each with different characteristics (e.g., signal strength and quality, latency, throughput, support for different services, power consumption profiles, etc.). Accordingly, part of wireless device operation may include determining which wireless communication technology or technologies to use to fulfill its wireless communication needs at any given time. Because of the potentially differing characteristics of different possible wireless communication technologies, such determination can have a significant impact on the wireless device performance and user experience.

Thus, it may be beneficial to provide RAT prioritization techniques for use when obtaining cellular service, e.g., to help improve device performance and user experience. To illustrate one such set of possible techniques, FIG. 5 is a flowchart diagram illustrating a method for determining a RAT to prioritize when obtaining cellular service in a wireless communication system, at least according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, a wireless device may determine a preferred RAT to use to obtain cellular service. For example, the wireless device may determine whether to prioritize obtaining cellular service using a first RAT or a second RAT. Alternatively, or in addition, the wireless device may determine whether to deprioritize obtaining cellular service using a certain RAT. In some embodiments, the first RAT may include LTE and the second RAT may include standalone NR. In other embodiments, the preferred RAT may be selected from other RATs (e.g., additionally or alternatively to LTE and/or standalone NR). Selecting the preferred RAT may be based on any of a variety of considerations, and may possibly be based on a set of multiple conditions and/or triggers.

According to some embodiments, one or more conditions and/or triggers for determining the preferred RAT and/or determining whether to deprioritize a certain RAT may be based on characteristics of and/or conditions present at the wireless device. For example, the wireless device could be configured to prioritize one (e.g., the first) RAT and/or deprioritize another (e.g., the second) RAT when operating in a low power mode (e.g., if battery reserves are below a certain threshold and/or such an operating mode is configured by a user of the wireless device), and/or to prioritize another (e.g., the second) RAT when operating in a normal power mode (e.g., if battery reserves are above a certain threshold and/or such an operating mode is configured by a user of the wireless device), if prioritizing the first RAT and/or deprioritizing the second RAT is expected to result in less power consumption than prioritizing the second RAT. Any number of other wireless device characteristics and/or conditions may also or alternatively be configured, e.g., for increasing the likelihood that the selected preferred RAT provides the desired power consumption and performance profile and/or for any of various other reasons.

In some instances, the preferred RAT may also or alternatively be selected based at least in part on one or more cellular network characteristics. The conditions, triggers, and/or characteristics that are based on the cellular network (or multiple cellular networks) may similarly be configured to increase the likelihood that the selected preferred RAT provides the desired power consumption and performance profile and/or for any of various other possible reasons. For example, in some instances, one or more characteristics of a cellular network that operates according to the first RAT and/or one or more characteristics of a cellular network that operates according to the second RAT may reflect whether prioritizing the first RAT and/or deprioritizing the second RAT would actually result in less power consumption than prioritizing the second RAT. Such characteristics could also or alternatively be reflective of which RAT(s) could provide adequate service for the wireless device's needs, and/or other aspects that may influence whether prioritization of the first (or deprioritization of the second) RAT or prioritization of the second RAT would provide better user experience to a user of the wireless device.

The cellular network characteristics may include those of a cellular network that operates according to the first RAT and/or those of a cellular network that operates according to the second RAT. In some instances, the cellular network characteristics may include whether a cellular network, such as a home public land mobile network (HPLMN) or registered public land mobile network (RPLMN) of the wireless device, provides service according to one or both of the first RAT and/or the second RAT. The wireless device may be able to obtain information indicating such service availability based on cell measurements performed by the wireless device, cell system information, stored information (e.g., indicating PLMN ID, access point name (APN), data network name (DNN), RAT, etc. for the HPLMN, RPLMN, and/or one or more other PLMNs active in the location of the wireless device), and/or any of various other possible sources. As one possibility, if the HPLMN of the wireless device only provides cellular service according to the second RAT, the wireless device may determine to prioritize the second RAT over the first RAT, e.g., even if one or more other conditions or triggers for possibly prioritizing the first RAT over the second RAT are present. Such a condition may help reduce revenue loss for the HPLMN of the wireless device, at least according to some embodiments, for example since in such a scenario it may be the case that the wireless device could only obtain cellular service using the first RAT by roaming to a different public land mobile network (PLMN) than the HPLMN of the wireless device.

As another example, the cellular network characteristics may include behavioral characteristics and/or service availability from a cellular network. For example, if the wireless device (e.g., initially) determines to prioritize the first RAT or deprioritize the second RAT and accordingly attempts to attach to or perform a tracking area update with a cellular network that operates according to the first RAT, but is rejected, or is only able to obtain limited service, or is redirected to the second RAT, the wireless device may determine to instead prioritize or stop deprioritizing the second RAT, e.g., based at least in part on being able to obtain limited or no service or being redirected to the second RAT. This may help avoid scenarios in which the wireless device that is trying to reduce power consumption by deprioritizing the second RAT is unable to obtain sufficient access to cellular service via another RAT, which could negatively impact user experience more than an increased power consumption level, at least according to some embodiments. Note that such a condition may be implemented based on the current tracking area or RPLMN of the wireless device, in some embodiments. For example, in some instances, the wireless device may reset such a condition (e.g., potentially again allowing deprioritization of the second RAT) if the wireless device moves to a different tracking area or PLMN.

As yet another example, the cellular network characteristics may include cell strength, cell quality, and/or other cell measurements for one or more cells that operate according to the first RAT and/or the second RAT. For example, if a wireless device meets at least one condition configured to trigger deprioritizing the second RAT (e.g., to reduce power consumption), but the best available cell that operates according to the first RAT has a poor signal strength and/or quality (e.g., below one or more configured thresholds) while the best available cell that operates according to the second RAT as a good signal strength and/or quality (e.g., above one or more configured thresholds), it may be the case that deprioritizing the second RAT would not actually reduce wireless device power consumption (e.g., due to an increased cell measurement burden, higher error rates and/or lower throughput, etc., at the cell that operates according to the first RAT due to the poor signal strength/quality). Accordingly, at least in some instances, the wireless device may determine the preferred RAT to use to obtain cellular service (e.g., including whether to prioritize the first RAT, deprioritze the second RAT, prioritize the second RAT, etc.) based on one or more cell measurements for one or more of a cell that operates according to the first RAT and/or a cell that operates according to the second RAT.

As still a further possibility, serving cell system information may be used by the wireless device when determining the preferred RAT to use to obtain cellular service. Such system information could include any of various possible types of information, and may potentially even include whether certain information is absent or unavailable from the serving cell system information. As one such possibility, the system information used by the wireless device could include information indicating whether an interworking interface between the first RAT and the second RAT (e.g., an IWK N26 interface in the case of LTE and NR, as one possibility) is available for the serving cell of the wireless device. As another such possibility, the system information used by the wireless device could include system information block (SIB) 5 information supporting cell re-selection from the second RAT to the first RAT, or the absence thereof. For example, in some embodiments, if a wireless device meets at least one condition configured to trigger deprioritizing the second RAT while attached to a serving cell that operates according to the second RAT, but no interworking interface with the first RAT or support for cell re-selection to the first RAT is available (or information indicating availability is not provided), the wireless device may determine to not deprioritize the second RAT.

As another possibility for using serving cell system information when determining the preferred RAT to use to obtain cellular service, the wireless device may determine whether the serving cell of the wireless device is available as a non standalone cell (NR NSA) along with a standalone (NR SA) based at least in part on serving cell system information, and may determine the preferred RAT to use to obtain cellular service based at least in part on whether the serving cell is available as a non standalone cell along with a standalone cell. For example, in some embodiments, if a wireless device meets at least one condition configured to trigger deprioritizing the second RAT (e.g., to reduce power consumption), while attached to a serving cell that operates according to the second RAT as a standalone cell, but the serving cell is also available as a non standalone cell, the wireless device may determine to not deprioritize the second RAT. This may help prevent the possibility that after deprioritizing the second RAT, the wireless device establishes a connection with a cell according to the first RAT, and the cell that operates according to the first RAT adds the former serving cell that operates according to the second RAT as a non standalone cell, which could mitigate the potential reduced power consumption from deprioritizing the second RAT, or even result in increased power consumption.

Note that the wireless device may determine whether the serving cell of the wireless device is available as a non standalone cell, and/or whether one or more other cells that operate according to the second RAT may be available as non standalone cells, based on information stored by the wireless device, e.g., in addition or as an alternative to making such a determination based on serving cell system information. For example, in some instances, the wireless device may store information indicating cell characteristics for one or more cells based on previous wireless links established between the wireless device and those cells. As another possibility, the wireless device may store information indicating cell characteristics for one or more cells based on aggregated (e.g., crowdsourced) data from multiple wireless devices, such as data that is anonymously collected from certain wireless devices (e.g., those of a specific model or type, those sold by a specific vendor, etc.) with the consent of users of those wireless devices.

As still another possibility, the wireless device may determine whether to prioritize or deprioritize a RAT to use to obtain cellular service based at least in part on Wi-Fi service characteristics and/or availability for the wireless device. For example, in some embodiments, the wireless device may be configured to trigger deprioritizing the second RAT when (e.g., possibly along with one or more other conditions) Wi-Fi service of at least a certain quality (e.g., Wi-Fi signal strength and/or quality meet one or more threshold requirements) is available and has been for at least a certain amount of time (e.g., at least a configured time duration has passed with the Wi-Fi service meeting the strength/quality requirements continuously throughout the duration). Said another way, if Wi-Fi is available but signal strength/quality is inconsistent, the wireless device may refrain from deprioritizing the second RAT, e.g., to decrease the likelihood that the inconsistency of the Wi-Fi service could negatively impact user experience, at least according to some embodiments.

In some embodiments, an additional or alternative consideration for determining a preferred RAT to use to obtain cellular service may include cell bandwidth for one or more cells. For example, in some embodiments, if a primary serving cell of the wireless device that operates according to the second RAT has a cell bandwidth that is greater than a certain threshold, and any other configured conditions for deprioritizing the second RAT are met, the wireless device may determine to deprioritize the second RAT, but if the primary serving cell has a cell bandwidth that is less than a configured threshold, even if any other configured conditions for deprioritizing the second RAT are met, the wireless device may determine to not deprioritize the second RAT.

A still further possible consideration for determining a preferred RAT to use to obtain cellular service may include whether an emergency voice call is active (or possibly was active within a certain amount of time). For example, in some embodiments, if an emergency voice call is active (or possibly has recently been active), even if any other configured conditions for deprioritizing the second RAT are met, the wireless device may determine to not deprioritize the second RAT.

In 504, the wireless device may establish a wireless link with a cellular base station. The wireless link may be established according to the determined preferred RAT, e.g., based at least in part on the determination of whether to prioritize/deprioritize obtaining cellular service using the first/second RAT. Thus, as one possibility, if the wireless device determines to prioritize standalone NR service (or possibly to not deprioritize/reprioritize standalone NR service), the wireless link may include a cellular link according to 5G NR. For example, the wireless device may establish a session with an AMF entity of the cellular network by way of one or more gNBs that provide radio access to the cellular network. As another possibility, if the wireless device determines to prioritize LTE service (or possibly to deprioritize standalone NR service), the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities.

Note that if the wireless device determines to change the preferred RAT to use to obtain cellular service, the wireless device may detach from the current serving of the wireless device and re-select to a serving cell that operates according to the new preferred RAT, or otherwise establish a wireless link with a cell that operates according to the new preferred RAT. For example, such a scenario may occur if the wireless device determines to prioritize the first RAT (or deprioritize the second RAT) while attached to a cell that operates according to the second RAT, if the wireless device determines to prioritize the second RAT (e.g., possibly including re-prioritizing or stopping deprioritizing the second RAT) while attached to a cell that operates according to the first RAT.

Thus, at least according to some embodiments, the method of FIG. 5 may be used by a wireless device to determine a preferred RAT to use to obtain cellular service. Use of the method may improve the match between wireless device needs/priorities and the power consumption and performance profiles of possible/available RATs, which may in turn provide better user experience for wireless device users, among other possible benefits, at least in some instances.

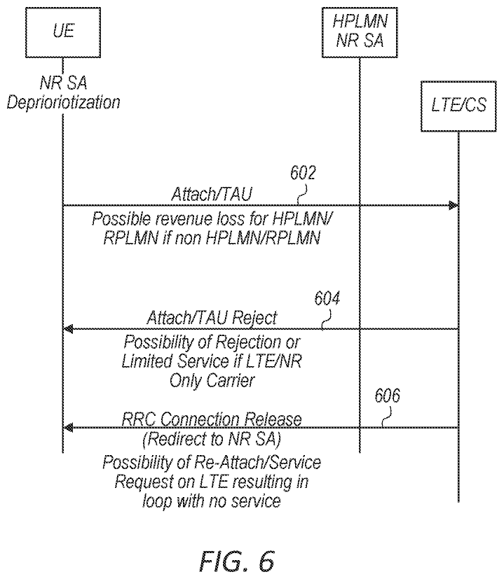

### FIGS. 6-13 and Additional Information

FIGS. 6-13 illustrate further aspects that might be used in conjunction with the method of FIG. 5 if desired. It should be noted, however, that the exemplary details illustrated in and described with respect to FIGS. 6-13 are not intended to be limiting to the disclosure as a whole: numerous variations and alternatives to the details provided herein below are possible and should be considered within the scope of the disclosure.

In some instances, a UE may benefit from deprioritizing camping on standalone 5G NR cells. For example, there may be some scenarios in which UE power consumption considerations and/or other UE based triggers for deprioritizing camping on NR SA cells are configured. When such a scenario occurs and NR SA is de-prioritized by a UE, it may be the case that NR to LTE (NR2L) induced re-selection may be performed, and LTE to NR (L2NR) re-direction may be blocked, e.g., by the UE baseband based at least in part on the NR SA deprioritization algorithm.

Such deprioritization may be temporary, and may also be reverted (e.g., NR SA camping may be reprioritized) under certain circumstances, such that when reverted the UE may reset and return to NR camping. This may include performing a RRC local release if the UE is in connected state, possibly including providing a custom signature to avoid key performance indicator (KPI) impact on the LTE cell and/or to facilitate mobility between LTE and NR. The subsequent connection establishment procedure may be paused or delayed to allow cell re-selection (e.g., to a now re-prioritized NR cell) to be performed (e.g., if a NR SA cell is available) before re-establishing a RRC connection.

As already noted, such deprioritization of NR may take place under certain selected circumstances. In addition to any UE based triggers (e.g., such as a trigger for reduced power consumption), such de-prioritization may also or alternatively depend at least in part on one or more network side considerations. For example, it may be the case that deprioritization of NR SA camping is triggered only when NR primary cell bandwidth is high (e.g., greater than a configured or specified amount), e.g., such that LTE camping may be expected to be consume less power than NR camping. Note also that it may be the case that a NR SA deprioritization algorithm may be configured to not be triggered, and/or to be reverted if currently active, if an emergency voice call (Voice/e911) is active, at least according to some embodiments.

In some instances, there may be any number of network characteristics and/or other considerations that could affect whether a UE determines to deprioritize NR camping, e.g., to avoid any of various potential issues that could arise if a UE were to do so. FIG. 6 illustrates exemplary aspects of possible scenarios in which deprioritizing NR camping could result in negative impacts to the UE and/or carrier, according to some embodiments.

As one example, if the home network (e.g., HPLMN) of a UE is a NR SA only network (e.g., if LTE and/or other legacy networks are only available through roaming, at least in some regions), deprioritizing NR SA camping may cause revenue loss for the home carrier. Thus, as shown, in 602, a successful attach or tracking area update (TAU) on LTE after NR deprioritization in such a scenario may result in revenue loss for the HPLMN or registered PLMN (RPLMN).

As another example, for a NR SA and LTE only network (e.g., no circuit switched (CS) network), if NR SA camping is deprioritized by a UE, as shown in 604, in case of an attach or TAU reject on LTE after NR deprioritization, the UE may stay in limited service (e.g., NR SA deprioritization, followed by LTE Attach/TAU reject, followed by determining that no CS network is available, resulting in UE limited service). As another possibility, as shown in 606, if the LTE network is designed to redirect a UE directly to NR during every attach or TAU procedure, a UE may be forced back and forth between NR and LTE by the combined NR deprioritization operation at the UE and the attempted redirection to NR by the LTE network, which may result in service to the UE being limited (e.g., NR SA deprioritization, followed by LTE Attach/TAU success, followed by RRC connection release with redirection information to NR SA, followed by the UE remaining in idle due to NR being depriorized, followed by a service request or LTE Reattach/TAU success, followed by another RRC connection release with redirection information to NR SA, and so on, in a continuous loop, resulting in UE limited service).

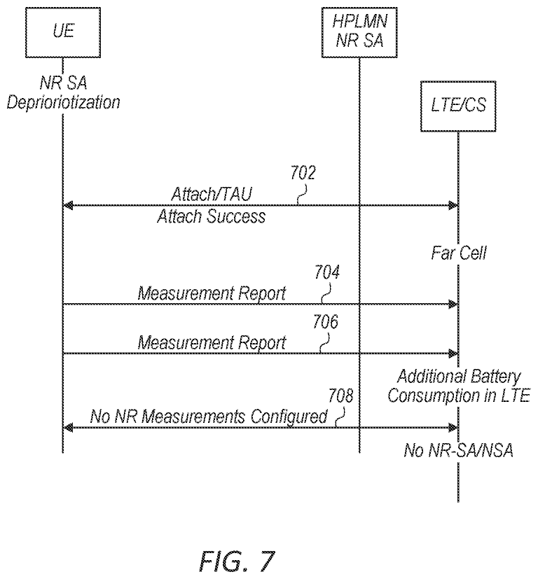

Another useful scenario to consider may include if the best available LTE cell at the location of the UE when NR camping is deprioritized is far from the UE or otherwise provides poor coverage. FIG. 7 illustrates exemplary aspects of one such possible scenario, according to some embodiments.

In such a scenario, the UE may frequently perform serving and/or neighbor cell measurements and send measurement reports while in LTE, which may cause more power consumption that idle/inactive mode NR SA operation would cause in the same location (e.g., depending on the available NR cell strength and/or configuration). For example, as shown, in 702, a successful attach or TAU procedure may be performed on LTE after NR deprioritization. In 704 and 706 (and possibly other instances), measurement reports may be configured for the far LTE cell. In some instances, as shown in 708, the network might not configure NR measurement reports in such a scenario, which may result in the UE effectively being stuck on LTE (e.g., without even NR NSA available).

As still another possibility, although deprioritizing NR SA may be beneficial in at least some instances in case of voice over Wi-Fi (VoWiFi) and/or Wi-Fi data handoff, in other instances deprioritizing NR SA camping could cause bad user experience and increased battery drain in case of patchy Wi-Fi coverage. For example, in case the UE attempts to perform heavy data communication using the patchy Wi-Fi coverage in the absence of NR SA connectivity due to the NR deprioritization, the UE may consume more power, experience worse call quality, and/or observe slower data transfers than if NR camping were not deprioritized, at least in some embodiments.

In order to account for such possible downsides to deprioritizing NR SA under certain circumstances, it may be possible for a UE to implement one or more conditions to deprioritizing NR SA (or configured to trigger reprioritization of NR SA is already deprioritized when such conditions occur), for example based on such cellular network characteristics and considerations.

As one possible example, a UE may be configured to implement NR SA deprioritization (e.g., assuming other conditions for such deprioritization are met) only if HPLMN/RPLMN LTE coverage is available, in order to avoid causing revenue loss for a NR SA only network operator.

As another possible example, a UE may be configured to reprioritize NR SA (e.g., if NR SA deprioritization has already been triggered) if the UE is only able to obtain limited service via LTE, if an attach/TAU reject occurs on LTE, if the UE is unable to obtain service on LTE for more than a configured duration (e.g., 20 seconds, as one possibility), and/or if no LTE service is available.

As a further possible example, a UE may be configured to check LTE coverage before triggering NR SA deprioritization. For example, the UE may be configured to deprioritize NR SA (if any other configured conditions for deprioritization are also met) if LTE cell strength and/or quality is better than a first configured threshold and NR SA cell strength and/or quality is worse than a second configured threshold, or if LTE cell strength and/or quality is worse than the second configured threshold and NR SA cell strength and/or quality is worse than the first configured threshold, but to not deprioritize NR SA if LTE cell strength and/or quality is worse than the first configured threshold and NR SA cell strength and/or quality is better than the second configured threshold.

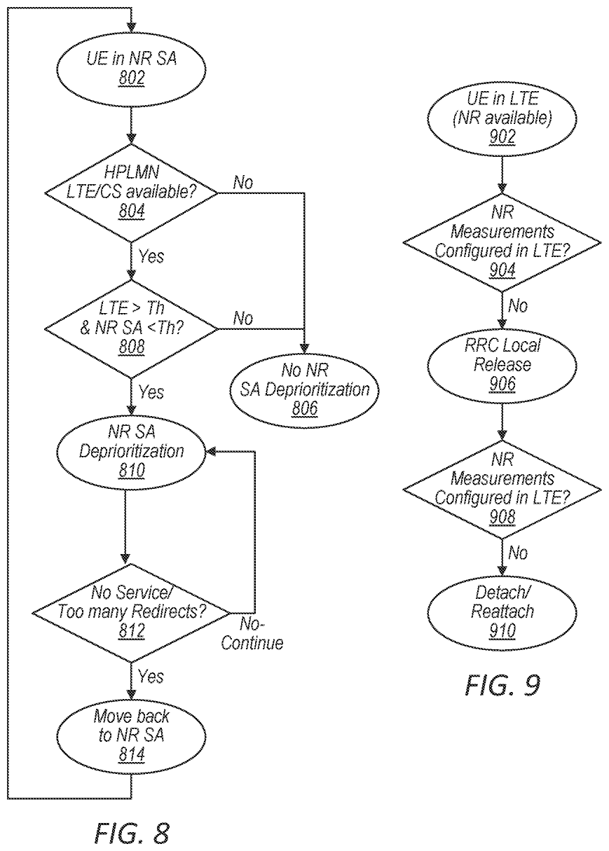

FIG. 8 illustrates exemplary aspects of a possible technique for determining whether to deprioririze NR SA camping that accounts for various possible network characteristics and conditions, according to some embodiments. As shown, in 802, a UE may initially be camped on a NR SA cell. In 804, the UE may determine if HPLMN LTE/CS service is available. If not, in 806, the UE may determine that no NR SA deprioritization can be triggered (e.g., at least in the current location and circumstances for the UE). In 808, if HPLMN LTE/CS service is available, the UE may determine whether LTE cell strength and NR SA cell strength meet certain configured threshold requirements for NR SA deprioritization. If not, the method may also proceed to step 806, and the UE may determine that no NR SA deprioritization can be triggered. In 810, if LTE cell strength and NR SA cell strength meet the configured threshold requirements for NR SA deprioritization, NR SA deprioritization may be allowed. Note that other conditions not shown in FIG. 8 (e.g., one or more UE based triggers, such as a trigger to reduce UE power consumption) may also be configured as requirements for NR SA deprioritization to actually be triggered, at least according to some embodiments. In 812, if NR SA deprioritization is triggered, the UE may determine whether the non NR SA service is acceptable to continue with the NR SA deprioritization, for example including determining whether the UE has no service in LTE or too many LTE redirections to NR have occurred. If the non NR SA service is acceptable (e.g., if the UE does not experience no LTE service or too many LTE redirections to NR), the UE may return to step 810 and continue with NR SA deprioritization. If the non NR SA service is not acceptable (e.g., if the UE does experience no LTE service or too many LTE redirections to NR), in 814, the UE may reprioritize NR SA camping, and return to step 802. Note that, at least according to some embodiments, if NR SA is reprioritized due to no LTE service or too many LTE redirections to NR, the UE may refrain from again deprioritizing NR SA while the UE remains in the same tracking area.

According to some embodiments, if the UE has no NR measurement configured when in LTE or after NR reprioritization, and the UE has information indicating that NR cell availability is present at its current location, the UE may perform a local RRC release, then (e.g., if needed) attempt to detach/reattach, e.g., to attempt to obtain NR measurement configuration information. FIG. 9 illustrates exemplary aspects of one such possible scenario, according to some embodiments. As shown, in 902, a UE may be in LTE with NR available. In 904, the UE may determine whether NR measurements are configured in LTE. In 906, if not, the UE may perform a RRC local release. In 908, the UE may determine if NR measurements are configured in LTE after the RRC release. In 910, if not, the UE may detach and reattach.

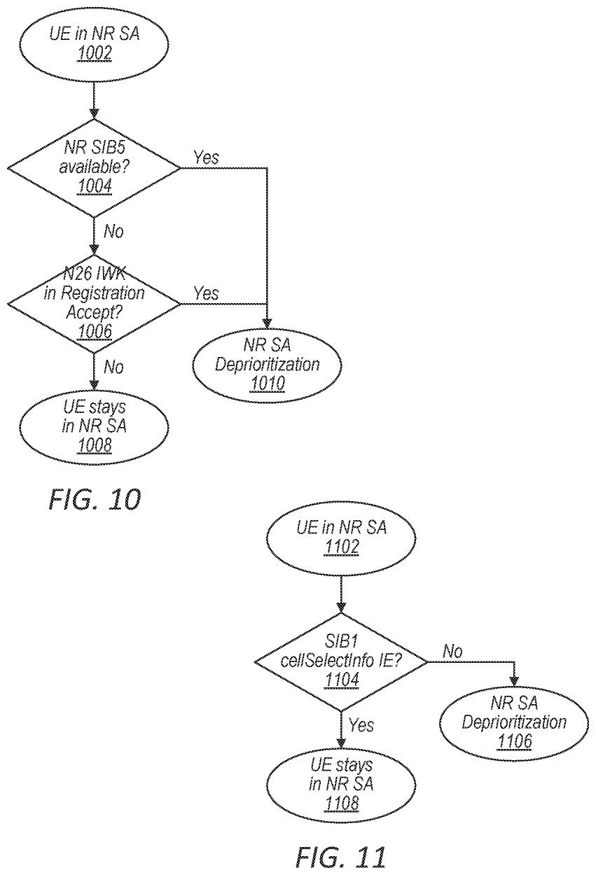

In some embodiments, one possible condition for NR SA deprioritization may include the availability of system information and/or NR LTE interworking functionality to support reselection to LTE from NR. For example, NR2L reselection may not be possible when NR SIBS is not available to the UE (e.g., if the network does not respond to a request for it as an on-demand SIB or it is not broadcasted), and/or if a N26 interface between the AMF and MME of the 5G core (5GC) and evolved packet core (EPC) networks is not supported. FIG. 10 illustrates exemplary aspects of one such possible approach to implementing such a condition, according to some embodiments. As shown, in 1002, a UE may initially be camped on a NR SA cell. In 1004, the UE may check if NR SIBS information is available from the NR SA cell. If so, in 1010, the UE may determine that NR SA deprioritization can be triggered (e.g., if any other configured conditions for triggering NR SA deprioritization are also met). If not, in 1006, the UE may determine if N26 interworking (IWK) is indicated (e.g., if the IWK (N26) information element is present in the registration accept message from the 5GC network) for the NR SA cell. If so, the UE may proceed to step 1010 and may determine that NR SA deprioritization can be triggered. If not, in 1008, the UE may stay in NR SA, and may determine to not deprioritize NR SA.

Another possible condition for NR SA deprioritization may include whether NR NSA is supported by a NR SA cell. For example, if NR NSA is supported, deprioritizing NR SA and reselecting to LTE may still result in a NR NSA cell being added, which may negate any potential power consumption reduction from NR SA deprioritization, at least in some circumstances. FIG. 11 illustrates exemplary aspects of one such possible approach to implementing such a condition, according to some embodiments. As shown, in 1102, a UE may initially be camped on a NR SA cell. In 1104, the UE may check if NR SIB1 includes cellSelectionInfo IE(s). Presence of this IE may indicate that the gNB is also supported as a NSA cell; absence of this IE may indicate that the gNB is not supported as a NSA cell, at least according to some embodiments. Accordingly, if the cellSelectionInfo IE is not present, in 1106, the UE may determine that NR SA deprioritization can be triggered (e.g., if any other configured conditions for triggering NR SA deprioritization are also met). If not, in 1108, the UE may stay in NR SA, and may determine to not deprioritize NR SA.

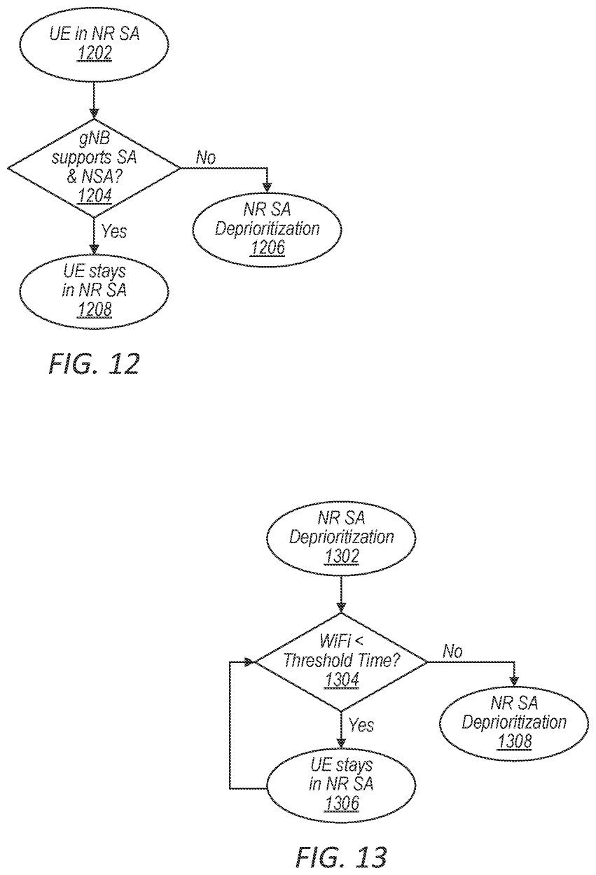

As another (additional or alternative) possible condition for NR SA deprioritization relating to whether NR NSA is available, information stored by a UE may be consulted when determining whether to deprioritize NR SA camping. For example, a UE may store a cell database (or other data structure) that indicates known gNBs, possibly including indicating whether those gNBs support SA and/or NSA operation. FIG. 12 illustrates exemplary aspects of one such possible approach to implementing such a condition, according to some embodiments. As shown, in 1202, a UE may initially be camped on a NR SA cell. In 1204, the UE may check if the gNB providing the NR SA cell supports NSA in addition to SA operation, based on the information stored by the UE. If the gNB does not support both SA and NSA, in 1206, the UE may determine that NR SA deprioritization can be triggered (e.g., if any other configured conditions for triggering NR SA deprioritization are also met). If the gNB does support both SA and NSA, in 1208, the UE may stay in NR SA, and may determine to not deprioritize NR SA.

Such techniques may help avoid scenarios that could result in increased battery consumption, such as could occur if a carrier has a NR SA cell deployed in sub-6 GHz spectrum and mmWave spectrum carrier aggregation component. In such a scenario, when NR SA is deprioritized and LTE+mmWave NR NSA service is configured, a UE may experience higher power consumption than for NR SA service. Accordingly, delaying/deferring deprioritization of NR SA camping if the same cell/region supports NR SA and NSA operation and staying on a NR SA cell in such a scenario may reduce power consumption by the UE, at least according to some embodiments.

A still further possible condition for NR SA deprioritization may relate to the Wi-Fi coverage/service available to a UE. In particular, it may be useful to configure a UE with one or more conditions to avoid a ping pong effect on NR SA deprioritization in the event of patchy Wi-Fi signal strength/availability. FIG. 13 illustrates exemplary aspects of one such possible approach to implementing such a condition, according to some embodiments. As shown, in 1302, a UE may have NR SA deprioritization triggered, at least in part based on Wi-Fi being available. In 1304, the Wi-Fi may become unavailable or signal strength may cross (fall below) a configured threshold, which may trigger reprioritization of NR SA. The UE may check for whether Wi-Fi becomes available again (e.g., with signal strength above a configured threshold) for at least a configured amount of time. If Wi-Fi is still unavailable or has been available for less than the configured duration of time continuously, in 1306, the UE may remain in NR SA (e.g., may continue with NR SA reprioritized). The UE may return to step 1304 to continue assessing whether Wi-Fi has been available for at least the configured duration of time continuously. If Wi-Fi has been available for at least the configured duration of time continuously, in 1308, the UE may resume NR SA deprioritization. Inducing such a delay timer for Wi-Fi based NR SA deprioritization may help avoid scenarios in which a UE prematurely resumes deprioritizing NR SA in inconsistent Wi-Fi coverage.

Note that in some instances, it may also be possible to implement a condition on NR SA deprioritization based on relative Wi-Fi power consumption versus NR power consumption, potentially including in relation to voice over NR (VoNR) availability. Such a condition may be enabled and disabled based at least in part on voice over Wi-Fi (VoWiFi), voice over LTE (VoLTE), and VoNR availability, at least in some instances. For example, if VoNR is available, and Wi-Fi is determined to have higher power consumption than NR SA (e.g., due to relatively low Wi-Fi signal strength and/or relatively high NR SA signal strength), it may be the case that a UE determines to stay on NR SA (e.g., including on VoNR) rather than to deprioritize NR SA, e.g., even if other triggers/conditions for deprioritizing NR SA are met.

In the following further exemplary embodiments are provided.

One set of embodiments may include a wireless device, comprising: an antenna; a radio operably coupled to the antenna; and a processor operably coupled to the radio; wherein the wireless device is configured to: determine whether to deprioritize obtaining cellular service using a radio access technology, wherein whether to deprioritize obtaining cellular service using the RAT is determined based at least in part on one or more cellular network characteristics; and establish a wireless link with a cellular base station, wherein the wireless link with the cellular base station is established based at least in part on determining whether to deprioritize obtaining cellular service using the radio access technology.

According to some embodiments, wherein a home public land mobile network (HPLMN) of the wireless device provides cellular service using the RAT, wherein whether to deprioritize obtaining cellular service using the RAT is determined based at least in part on whether the HPLMN of the wireless device also provides cellular service using at least one other RAT.

According to some embodiments, whether to deprioritize obtaining cellular service using the RAT is determined based at least in part on whether an interworking interface with another RAT is available from a cell that operates according to the RAT.

According to some embodiments, whether to deprioritize obtaining cellular service using the RAT is determined based at least in part on whether system information supporting reselection to another RAT is available from a cell that operates according to the RAT.

According to some embodiments, whether to deprioritize obtaining cellular service using the RAT is determined based at least in part on whether a cell that operates according to the RAT is available as a non standalone cell.

According to some embodiments, whether to deprioritize obtaining cellular service using the RAT is determined based at least in part on whether Wi-Fi service is available to the wireless device for at least a configured amount of time.

According to some embodiments, whether to deprioritize obtaining cellular service using the RAT is determined based at least in part on one or more cell strength measurements for a cell that operates according to the RAT and for a cell that operates according to another RAT.

Another set of embodiments may include a method, comprising: by a wireless device: determining whether to prioritize obtaining cellular service using a first radio access technology (RAT) or a second RAT, wherein whether to prioritize obtaining cellular service using the first RAT or the second RAT is determined based at least in part on one or more cellular network characteristics; determining whether a cell that operates according to the second RAT is available as a non standalone cell, wherein whether to prioritize obtaining cellular service using the first RAT or the second RAT is determined based at least in part on whether the cell that operates according to the second RAT is available as a non standalone cell; and establishing a wireless link with a cellular base station.

According to some embodiments, a home public land mobile network (HPLMN) of the wireless device provides cellular service using the second RAT, wherein whether to prioritize obtaining cellular service using the first RAT or the second RAT is determined based at least in part on whether the HPLMN of the wireless device also provides cellular service using the first RAT.

According to some embodiments, the method further comprises: initially determining to prioritize obtaining cellular service using the first RAT; determining that limited cellular service or no cellular service is available using the first RAT; and determining to prioritize obtaining cellular service using the second RAT based at least in part on limited cellular service or no cellular service being available using the first RAT.

According to some embodiments, the method further comprises: performing one or more cell measurements on a cell that operates according to the first RAT; and performing one or more cell measurements on a cell that operates according to the second RAT, wherein whether to prioritize obtaining cellular service using the first RAT or the second RAT is determined based at least in part on the one or more cell measurements on the cell that operates according to the first RAT and the one or more cell measurements on the cell that operates according to the second RAT.

According to some embodiments, whether the cell that operates according to the second RAT is available as a non standalone cell is determined based at least in part on system information provided by the cell that operates according to the second RAT.

According to some embodiments, whether the cell that operates according to the second RAT is available as a non standalone cell is determined based at least in part on information stored by the wireless device indicating cell characteristics for the cell that operates according to the second RAT, wherein the information stored by the wireless device is based on one or more of a previous wireless link between the wireless device and the cell that operates according to the second RAT or aggregated data from multiple wireless devices.

According to some embodiments, the first RAT is long term evolution (LTE), wherein the second RAT is New Radio (NR) Standalone (SA).

Yet another set of embodiments may include an apparatus, comprising: a processor configured to cause a wireless device to: select a preferred radio access technology (RAT) to use to obtain cellular service, wherein a first RAT is initially selected as the preferred RAT to use to obtain cellular service, attempt to obtain cellular service using the first RAT; receive multiple indications redirecting the wireless device from the first RAT to a second RAT; and select the second RAT as the preferred RAT to use to obtain cellular service based at least in part on a number of indications redirecting the wireless device to the second RAT exceeding a configured threshold.

According to some embodiments, the processor is further configured to cause the wireless device to: determine that limited or no service is available using the first RAT; and select the second RAT as the preferred RAT to use to obtain cellular service based at least in part on limited or no service being available using the first RAT.

According to some embodiments, the preferred RAT is selected based at least in part on cell strength measurements for each of a cell that operates according to the first RAT and a cell that operates according to the second RAT.

According to some embodiments, the preferred RAT is selected based at least in part on system information for a serving cell for the wireless device.

According to some embodiments, the preferred RAT is selected based at least in part on one or more Wi-Fi service characteristics for the wireless device.

According to some embodiments, the preferred RAT is selected based at least in part on one or more wireless device characteristics.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A wireless device, comprising:
an antenna;
a radio operably coupled to the antenna; and
a processor operably coupled to the radio;
wherein the wireless device is configured to:
determine whether to deprioritize obtaining cellular service using a radio access technology, wherein whether to deprioritize obtaining cellular service using the RAT is determined based at least in part on one or more cellular network characteristics; and
establish a wireless link with a cellular base station, wherein the wireless link with the cellular base station is established based at least in part on determining whether to deprioritize obtaining cellular service using the radio access technology.

2. The wireless device of claim 1,
wherein a home public land mobile network (HPLMN) of the wireless device provides cellular service using the RAT,
wherein whether to deprioritize obtaining cellular service using the RAT is determined based at least in part on whether the HPLMN of the wireless device also provides cellular service using at least one other RAT.

3. The wireless device of claim 1,
wherein whether to deprioritize obtaining cellular service using the RAT is determined based at least in part on whether an interworking interface with another RAT is available from a cell that operates according to the RAT.

4. The wireless device of claim 1,
wherein whether to deprioritize obtaining cellular service using the RAT is determined based at least in part on whether system information supporting reselection to another RAT is available from a cell that operates according to the RAT.

5. The wireless device of claim 1,
wherein whether to deprioritize obtaining cellular service using the RAT is determined based at least in part on whether a cell that operates according to the RAT is available as a non standalone cell.

6. The wireless device of claim 1,
wherein whether to deprioritize obtaining cellular service using the RAT is determined based at least in part on whether Wi-Fi service is available to the wireless device for at least a configured amount of time.

7. The wireless device of claim 1,
wherein whether to deprioritize obtaining cellular service using the RAT is determined based at least in part on one or more cell strength measurements for a cell that operates according to the RAT and for a cell that operates according to another RAT.

8. A method, comprising:
by a wireless device:
determining whether to prioritize obtaining cellular service using a first radio access technology (RAT) or a second RAT, wherein whether to prioritize obtaining cellular service using the first RAT or the second RAT is determined based at least in part on one or more cellular network characteristics;
determining whether a cell that operates according to the second RAT is available as a non standalone cell, wherein whether to prioritize obtaining cellular service using the first RAT or the second RAT is determined based at least in part on whether the cell that operates according to the second RAT is available as a non standalone cell; and
establishing a wireless link with a cellular base station.

9. The method of claim 8,
wherein a home public land mobile network (HPLMN) of the wireless device provides cellular service using the second RAT,
wherein whether to prioritize obtaining cellular service using the first RAT or the second RAT is determined based at least in part on whether the HPLMN of the wireless device also provides cellular service using the first RAT.

10. The method of claim 8, wherein the method further comprises:
initially determining to prioritize obtaining cellular service using the first RAT;
determining that limited cellular service or no cellular service is available using the first RAT; and
determining to prioritize obtaining cellular service using the second RAT based at least in part on limited cellular service or no cellular service being available using the first RAT.

11. The method of claim 8, wherein the method further comprises:
performing one or more cell measurements on a cell that operates according to the first RAT; and
performing one or more cell measurements on a cell that operates according to the second RAT,
wherein whether to prioritize obtaining cellular service using the first RAT or the second RAT is determined based at least in part on the one or more cell measurements on the cell that operates according to the first RAT and the one or more cell measurements on the cell that operates according to the second RAT.

12. The method of claim 8,
wherein whether the cell that operates according to the second RAT is available as a non standalone cell is determined based at least in part on system information provided by the cell that operates according to the second RAT.

13. The method of claim 8,
wherein whether the cell that operates according to the second RAT is available as a non standalone cell is determined based at least in part on information stored by the wireless device indicating cell characteristics for the cell that operates according to the second RAT, wherein the information stored by the wireless device is based on one or more of a previous wireless link between the wireless device and the cell that operates according to the second RAT or aggregated data from multiple wireless devices.

14. The method of claim 8,
wherein the first RAT is long term evolution (LTE),
wherein the second RAT is New Radio (NR) Standalone (SA).

15. An apparatus, comprising:
a processor configured to cause a wireless device to:
select a preferred radio access technology (RAT) to use to obtain cellular service, wherein a first RAT is initially selected as the preferred RAT to use to obtain cellular service,
attempt to obtain cellular service using the first RAT;
receive multiple indications redirecting the wireless device from the first RAT to a second RAT; and
select the second RAT as the preferred RAT to use to obtain cellular service based at least in part on a number of indications redirecting the wireless device to the second RAT exceeding a configured threshold.

16. The apparatus of claim 15, wherein the processor is further configured to cause the wireless device to:
determine that limited or no service is available using the first RAT; and
select the second RAT as the preferred RAT to use to obtain cellular service based at least in part on limited or no service being available using the first RAT.

17. The apparatus of claim 15,
wherein the preferred RAT is selected based at least in part on cell strength measurements for each of a cell that operates according to the first RAT and a cell that operates according to the second RAT.

18. The apparatus of claim 15,
wherein the preferred RAT is selected based at least in part on system information for a serving cell for the wireless device.

19. The apparatus of claim 15,
wherein the preferred RAT is selected based at least in part on one or more Wi-Fi service characteristics for the wireless device.

20. The apparatus of claim 15,
wherein the preferred RAT is selected based at least in part on one or more wireless device characteristics.
